(19) United States
(12) Patent Application Publication
(10) Pub. No.: US 2023/0419143 A1
(43) Pub. Date: Dec. 28, 2023

(54) SYSTEMS AND METHODS FOR SIMULATION OF QUANTUM CIRCUITS USING EXTRACTED HAMILTONIANS

(71) Applicant: ALIBABA GROUP HOLDING LIMITED, George Town, Grand Cayman (KY)

(72) Inventors: Dawei DING, San Diego, CA (US); Huihai ZHAO, Beijing (CN); Hsiang-Sheng KU, Hangzhou, Zhejiang (CN)

(21) Appl. No.: 18/251,348

(22) PCT Filed: Nov. 20, 2020
(86) PCT No.: PCT/CN2020/130301

§ 371 Date: May 1, 2023

(51) Int. Cl. G06N 10/20; G06N 10/60

(52) U.S. Cl. CPC G06N 10/20; G06N 10/60

(57) ABSTRACT

A method for optimizing a quantum circuit is disclosured. The method comprises acquiring a representation of a quantum circuit comprising one or more qubits, transforming, by linear transformation, first Hamiltonian corresponding to the quantum circuit to generate modes, generating a third Hamiltonian by removing the free modes from a second Hamiltonian in which free modes are decoupled from non-free the second Hamiltonian, simulating a behavior of the quantum circuit using the third Hamiltonian, and adjusting a design of the quantum circuit based on the simulated behavior of the quantum circuit.

### TECHNICAL FIELD

The present disclosure generally relates to quantum computing, and more particularly, to simulation of quantum circuits by a classical computer using a Hamiltonian transformed to decouple free modes.

### BACKGROUND

A quantum computer can be implemented using a superconducting quantum circuit. Design and validation of the quantum computer may require simulation of the superconducting quantum circuit. Certain free modes of a superconducting quantum circuit (e.g., circuit modes with vanishing frequency, or the like) can interfere with the simulation of the circuit, without affecting the real-world performance of the circuit. Empirical measurements (for some simple circuits) or certain ad hoc mathematical techniques (for certain specific circuits) can address such interference. But such methods may be inapplicable to (or time-consuming and difficult to adapt to) more complicated or general circuits.

### SUMMARY OF THE DISCLOSURE

The disclosed systems and methods relate to simulation of a quantum circuit using a transformation of a Hamiltonian for the quantum circuit. The transformed Hamiltonian may exclude free modes that would otherwise interfere with simulation of the quantum circuit.

The disclosed embodiments include a method for optimizing a quantum circuit, comprising: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and, adjusting a design of the quantum circuit based on the simulated behavior of the quantum circuit.

The disclosed embodiments also include an apparatus for optimizing a quantum circuit, comprising: a memory for storing a set of instructions; and, at least one processor configured to execute the set of instructions to cause the apparatus to perform operations including: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and adjusting a design of the quantum circuit based on the simulated behavior of the quantum circuit.

The disclosed embodiments further include a non-transitory computer readable medium that stores a set of instructions that is executable by at least one processor of a computing device to perform a method for optimizing a quantum circuit, the method comprising: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and adjusting a design of the quantum circuit based on the simulated behavior of the quantum circuit.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

Embodiments and various aspects of present disclosure are illustrated in the following detailed description and the accompanying figures. Various features shown in the figures are not drawn to scale.

FIG. 1 illustrates an exemplary system for optimizing a quantum circuit, consistent with some embodiments of the present disclosure.

FIG. 2A illustrates an exemplary quantum circuit optimizer, consistent with some embodiments of the present disclosure.

FIG. 2B illustrates an exemplary quantum circuit simulator, consistent with some embodiments of the present disclosure.

FIG. 3A illustrates an example quantum circuit, consistent with some embodiments of the present disclosure.

FIG. 3B illustrates an example capacitance table of a quantum circuit of FIG. 3A, consistent with some embodiments of the present disclosure.

FIG. 4A illustrates an energy spectrum based on a Hamiltonian of a quantum circuit of FIG. 3A with free modes.

FIG. 4B illustrates an energy spectrum based on an extracted Hamiltonian of a quantum circuit of FIG. 3A, consistent with some embodiments of the present disclosure.

FIG. 5 illustrates an exemplary flow diagram of a method for optimizing a quantum circuit, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Quantum computers offer the ability to perform certain tasks (equivalently, solve certain problems) thought to be intractable to classical computers, including any possible future classical computers. To understand the advantage of quantum computers, it is useful to understand how they contrast to classical computers. A classical computer operates according to digital logic. Digital logic refers to a type of logic system that operates on units of information called bits. A bit may have one of two values, usually denoted 0 and 1, and is the smallest unit of information in digital logic. Operations are performed on bits using logic gates, which take one or more bits as input and give one or more bits as output. Typically, a logic gate usually only has one bit as output (though this single bit may be sent as input to multiple other logic gates) and the value of this bit usually depends on the value of at least some of the input bits. In modern-day computers, logic gates are usually composed of transistors and bits are usually represented as the voltage level of wires connecting to the transistors. A simple example of a logic gate is the AND gate, which (in its simplest form) takes two bits as input and gives one bit as output. The output of an AND gate is 1 if the value of both inputs is 1 and is zero otherwise. By connecting the inputs and outputs of various logic gates together in specific ways, a classical computer can implement arbitrarily complex algorithms to accomplish a variety of tasks.

On a surface level, quantum computers operate in a similar way to classical computers. A quantum computer operates according to a system of logic that operates on units of information called qubits (a portmanteau of “quantum” and “bit”). A qubit is the smallest unit of information in quantum computers and the qubit may have any linear combination of two values, usually denoted |0 [symbol] and |1 [symbol] . In other words, the value of a qubit, denoted |ψ [symbol] , could be equal to α|0 [symbol] +β|1 [symbol] for any combination of α and β 3 where α and β are complex numbers and |α|²+|β|²=1. Operations are performed on qubits using quantum logic gates, which take one or more qubits as input and gives one or more qubits as output. Given the low-level nature of most current quantum systems, quantum algorithms are typically expressed in terms of their underlying quantum circuits. In turn, quantum circuits are composed of quantum gates, the fundamental components that directly manipulate qubits.

A quantum computer can be implemented using a superconducting quantum circuit. Such a quantum computer can perform computations using discrete energy states of the superconducting circuit. As would be appreciated by those of skill in the art, design and validation of the quantum computer may involve simulating the behavior of the quantum circuit. When the quantum circuit possesses a free mode, the free mode can cause the simulated circuit to exhibit a continuous energy spectrum, hindering identification or analysis of the discrete energy states used to perform quantum computations. While negatively affecting simulations of quantum circuit, the presence of free modes does not appear to affect the energy spectrum or other observables of actual quantum circuits.

The design of the superconducting quantum circuit can determine whether the circuit possesses one or more free modes. Some circuits with beneficial characteristics may possess one or more free modes. As a non-limiting example, a circuit configured to float with respect to ground can exhibit reduced sensitivity to ground plane noise. Some general categories of circuits can possess one or more free modes. As a non-limiting example, a circuit may have one or more free modes when it includes at least one component connected only capacitively to other components of the circuit.

The relationship between superconducting quantum circuit design, whether the circuit possesses free modes, and the ability to simulate the circuit constitutes a technical problem in the development of quantum computers. While empirical measurements or certain ad hoc mathematical techniques can enable simulation of certain specific or simple superconducting quantum circuits, such methods may be inapplicable or too inefficient to apply to more complicated or general circuits. Accordingly, superconducting quantum circuit designs for quantum computing applications may be limited to simple designs, designs suitable for application of existing ad hoc analysis techniques, or designs lacking free modes.

The disclosed embodiments can enable simulation of the superconducting quantum circuit possessing free modes. The disclosed embodiments are not limited to simple quantum circuits and can be used with a general superconducting quantum circuit having the form given below in Equation 1. Accordingly, the disclosed embodiments enable the design and validation of complex superconducting quantum circuits and constitute a technological improvement in the field of quantum computing.

Consistent with disclosed embodiments, a Hamiltonian can be obtained for the superconducting quantum circuit using known circuit quantization techniques. The Hamiltonian can include capacitive, inductive, and (Josephson) junction terms associated with components of the circuit. The capacitive and inductive terms can be represented by coupling matrices that describe the charge and flux coupling between modes of the Hamiltonian (including self-couplings). Free modes can be associated with capacitive terms in the Hamiltonian, but not with inductive or junction terms. Charge operators of the free modes may appear in the Hamiltonian. Flux operators of the free modes may not appear in the Hamiltonian. Accordingly, these modes may be deemed “free” because they are not subject to a potential, in contrast with bound modes. In general, such free modes may have a continuous energy spectrum. Of particular relevance to this disclosure, free modes can be charge-coupled to other modes of the Hamiltonian.

Consistent with disclosed embodiments, the free modes in the Hamiltonian can be decoupled from the remaining modes using a linear transformation. As described herein, the linear transformation can be computed from the Hamiltonian. A naïve approach to decoupling the free modes might include applying the linear transformation to the charge coupling matrix. The linear transformation could perform Gaussian elimination on the charge coupling matrix. However, in some instances, preserving canonical commutation relations may require application of the same linear transformation or a similar linear transformation to the flux coupling matrix. Unfortunately, such a transformation of the flux coupling matrix could cause the free modes to no longer be “free”, preventing their elimination from the Hamiltonian. In contrast to the naïve approach and consistent with disclosed embodiments, the envisioned linear transformation can be used to perform Gaussian elimination on the inverse of the charge coupling matrix. To preserve canonical commutation relations, the linear transformation can also be performed on the flux coupling matrix. However, since free modes lack corresponding inductive terms in the flux coupling matrix, the corresponding rows and columns in the flux coupling matrix may be zero. Thus, in this instance, Gaussian elimination can preserve the flux coupling matrix. Following the transformation, the free modes of the transformed Hamiltonian may be decoupled from the remaining modes of the transformed Hamiltonian. An extracted Hamiltonian can then be obtained from the transformed Hamiltonian. The extracted Hamiltonian can represent the non-free modes of the superconducting quantum circuit. The superconducting circuit can then be simulated using the extracted Hamiltonian.

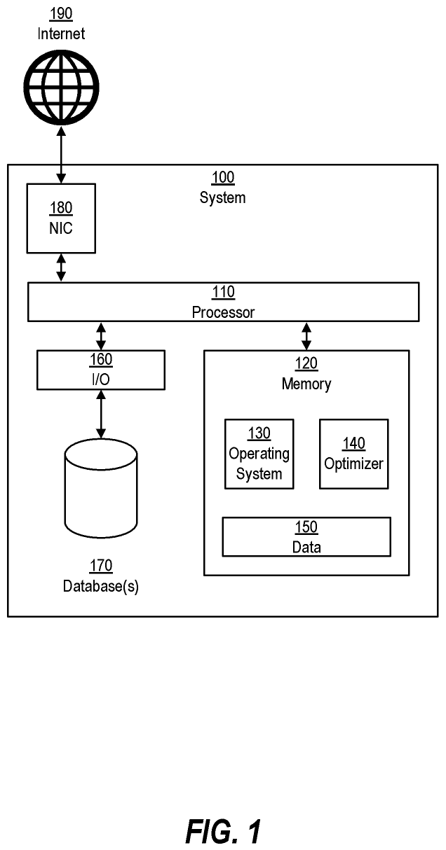

FIG. 1 illustrates an exemplary system 100 for optimizing a quantum circuit, consistent with some embodiments of the present disclosure. Although depicted as a server in FIG. 1, system 100 may comprise any computer, such as a desktop computer, a laptop computer, a tablet, or the like. As depicted in FIG. 1, system 100 may have a processor 110. Processor 110 may comprise a single processor or a plurality of processors. For example, processor 110 may comprise a CPU, a GPU, a reconfigurable array (e.g., an FPGA or other ASIC), or the like. Processor 110 may be in operable connection with a memory 120, an input/output module 160, and a network interface controller (NIC) 180.

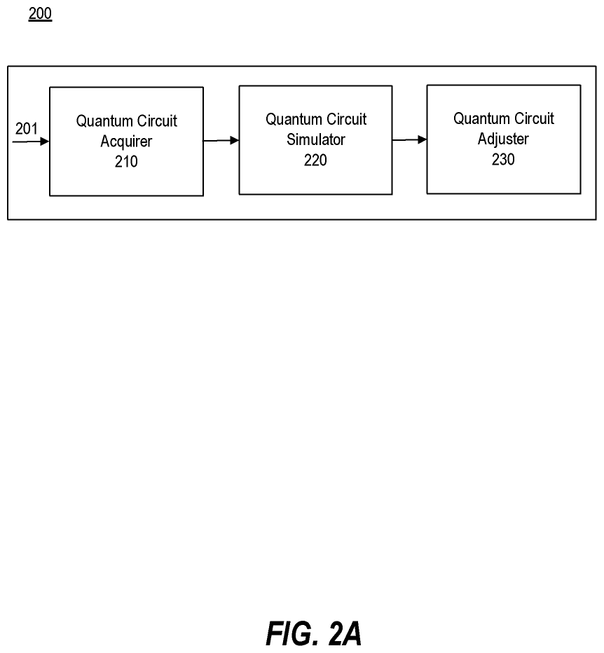

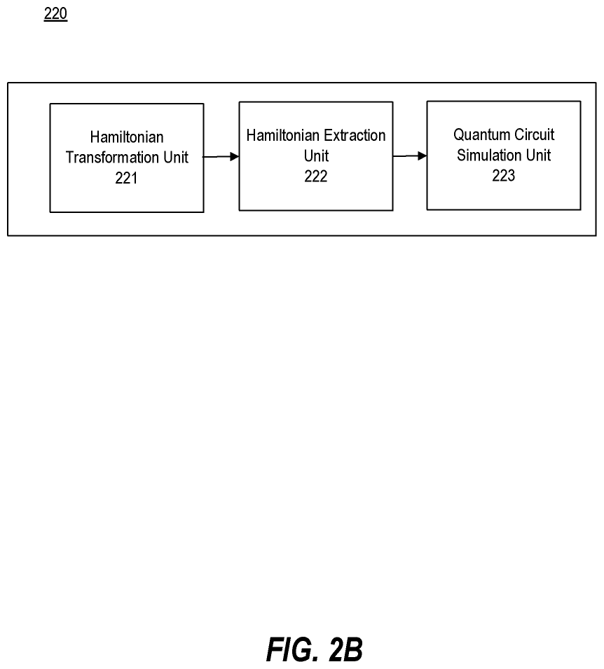

Memory 120 may comprise a single memory or a plurality of memories. In addition, memory 120 may comprise volatile memory, non-volatile memory, or a combination thereof. As depicted in FIG. 1, memory 120 may store one or more operating systems 130 and an optimizer 140. For example, optimizer 140 may include instructions to optimize a quantum circuit. Therefore, optimizer 140 may simulate and optimize one or more quantum circuits according to some embodiments of the present disclosure, which will be illustrated with respect to FIG. 2A and FIG. 2B. Input/output module (I/O) 160 may retrieve data from one or more databases 170. For example, database(s) 170 may include data structures describing quantum circuits. Memory 120 may further store data 150 retrieved from one or more databases 170. MC 180 may connect system 100 to one or more computer networks. As illustrated by FIG. 1, NIC 180 may connect system 100 to the Internet 190. System 100 may receive data and instructions over a network using MC 180 and may transmit data and instructions over a network using NIC 180.

FIG. 2A illustrates an exemplary quantum circuit optimizer, consistent with some embodiments of the present disclosure. In some embodiments, quantum circuit optimizer 200 can be implemented by processor 110 of FIG. 1, optimizer 140 of FIG. 1, or a combination of processor 110 and optimizer 140 of FIG. 1. As shown in FIG. 2A, quantum circuit optimizer 200 can comprise a quantum circuit acquirer 210, a quantum circuit simulator 220, and a quantum circuit adjuster 230.

Quantum circuit acquirer 210 can be configured to acquire a representation of quantum circuit 201. This representation can be generated by quantum circuit acquirer 210 (e.g. as the result of executing a program, through interactions with a user, or the like), received by quantum circuit acquirer 210 from another computing device, or retrieved from a non-transitory memory accessible to quantum circuit acquirer 210. The disclosed embodiments are not limited to how the input is represented (e.g., the data structure involved) or what the input represents (e.g., what quantum circuit representation the input is using). For example, the disclosed embodiments are not limited to using a particular data structure to acquire, store, or process quantum circuit 201. Likewise, the logical representation of quantum circuit 201 is not limited to a particular way to indicate the logical relationships between the components.

Quantum circuit simulator 220 can be configured to simulate a behavior of quantum circuit 201. As described herein, quantum circuit simulator 220 can be configured to generate an original Hamiltonian for quantum circuit 201, extract a Hamiltonian corresponding to the non-free modes of quantum circuit 201 from the original Hamiltonian, and simulate the dynamics of quantum circuit 201. For example, quantum circuit simulator 220 can simulate the time evolution of the state of the quantum circuit (e.g., the time evolution of the states of the modes for the quantum circuit). In various instances, quantum circuit simulator 220 can simulate a response of the quantum circuit to an input or other perturbation.

The process of removing free modes from an original Hamiltonian of quantum circuits will be illustrated referring to FIG. 2B, which illustrates an exemplary quantum circuit simulator, consistent with some embodiments of the present disclosure. As shown in FIG. 2B, quantum circuit simulator 220 can comprise Hamiltonian transformation unit 221, Hamiltonian extraction unit 222, and quantum circuit simulation unit 223.

Hamiltonian transformation unit 221 can be configured to generate a transformed Hamiltonian of quantum circuit 201 based on an original Hamiltonian of quantum circuit 201. According to some embodiments of the present disclosure, the transformed Hamiltonian can be generated by linearly transforming the original Hamiltonian to decouple free modes from other circuit modes in the transformed Hamiltonian.

As would be appreciated by those of skilled in the art, the original Hamiltonian for a quantum circuit can be derived in a variety of ways. As a non-limiting example, a Hamiltonian for a general superconducting quantum circuit can be derived using the method disclosed in “Circuit theory for decoherence in superconducting charge qubits,” G. Burkard, Physical Review B, April 2005, which is hereby incorporated by reference herein in its entirety and will be referred as Burkard in the present disclosure. In Burkard, the derived dissipation-less Hamiltonian of a general superconducting quantum circuit (e.g., quantum circuit 201) takes the form below:

$$H = \frac{1}{2} {( \vec{Q} - {C}_{V} \vec{V} )}^{T} {C}^{- 1} ( \vec{Q} - {C}_{V} \vec{V} ) - {\sum }_{i = 1}^{{n}_{J}} {E}_{J , i} cos ( \frac{2 π}{{Φ}_{0}} {Φ}_{i} ) + \frac{1}{2} {\vec{Φ}}^{T} {M}_{0} \vec{Φ} + {\vec{Φ}}^{T} N \vec{{Φ}_{x}} \qquad ( Equation 1 )$$

Here, \vec{Φ} and \vec{Q} are vectors of a flux operator and a charge operator for circuit modes of quantum circuit 201. \vec{Φₓ} denotes externally applied magnetic fluxes, Φ₀ is the flux quantum, and Φᵢ is a flux variable. \vec{V} is a vector of voltage biases in quantum circuit 201 and C⁻¹, M₀, N, and C_{V} are the charge coupling matrix, flux coupling matrix, external flux coupling matrix, and voltage coupling matrix, respectively. n_{J} is the number of Josephson junctions and E_{J,i} is the characteristic energy scale of each Josephson junction.

In some embodiments, a number F of free modes of quantum circuit 201 can be given as:

F≡dim(ker(M₀)∩ker(N^{T})∩V_{L}) (Equation 2).

Here, V_{L} is the subspace spanned by inductor fluxes. As denoted in Equation 2, the number F of free modes can be defined as a dimension of subspace(s), which are common in the kernel of flux coupling matrix M₀, the kernel of transposed external flux coupling matrix N^{T}, and the subspace V_{L} spanned by inductor fluxes of quantum circuit 201. In some embodiments, modes in quantum circuit 201 may have a vanishingly small potential term. While in such cases, no modes may be free, modes satisfying a thresholding criterion can be deemed to be free modes. For example, a mode in the Hamiltonian having a potential value smaller than the threshold can be treated as a free mode although the potential value of the mode may not be zero.

According to some embodiments of the present disclosure, flux operators \vec{Φ} and charge operators \vec{Q} can take forms such that free modes can be explicit in the derived Hamiltonian (e.g., represented as Equation 1). In some embodiments (e.g., via an appropriate transformation that diagonalizes the intersection of subspaces in Equation 2), flux operators \vec{Φ} can be represented as \vec{Φ}=[Φ₁, . . . , Φ_{F}, . . . , Φₙ], where Φ₁, . . . , Φ_{F} are flux operators for free modes, Φ_{F+1}, . . . , Φₙ are flux operators for non-free modes, and n is the total number of modes in the Hamiltonian. Similarly, charge operators \vec{Q} can be represented as \vec{Q}=[Q₁, . . . , Q_{F}, . . . , Qₙ], where Q₁, . . . , Q_{F} are charge operators for free modes and Q_{F+1}, . . . , Qₙ are charge operators for non-free modes. Consistent with this representation of flux operators \vec{Φ} and charge operators \vec{Q}, the elements of first F rows of external flux coupling matrix N and first F rows and first F columns of flux coupling matrix M₀ may all be zero.

In some embodiments, a transformed Hamiltonian that decouples free modes from non-free modes can be obtained, e.g., by linearly transforming circuit modes of quantum circuit 201 to effectively perform Gaussian elimination on the inverse of charge coupling matrix C⁻¹ (e.g., C). The same Gaussian elimination can then be performed on flux coupling matrix M₀, in accordance with the canonical transformation requirement. Accordingly, the transformed Hamiltonian will possess the same number of free modes as the original Hamiltonian. The extracted Hamiltonian can then be obtained by removing the free modes from the transformed Hamiltonian.

Consistent with disclosed embodiments, a transform matrix W can be defined such that free modes components can be decoupled from non-free modes components in charge coupling matrix C⁻¹. Charge coupling matrix C⁻¹ can be an inverse of effective capacitance matrix C of quantum circuit 201, which can be positive definite. For f∈{1, 2, . . . , F}, matrices W_{f} and C_{f} can be iteratively defined. Matrix W_{f} can be defined as an n×n identity matrix, except for column f, which has entries:

$${( {W}_{f} )}_{if} ≡ - \frac{{( {C}_{f - 1} )}_{if}}{{( {C}_{f - 1} )}_{ff}}$$

where matrix C_{f} is defined as C_{f}≡W_{f} C_{f-1}W_{f}^{T}. Matrix C₀ can be defined as the effective capacitance matrix C of quantum circuit 201. Because matrix C_{f-1} is positive definite, matrix W_{f} can be proven by induction to be well-defined (and therefore element (C_{f-1})_{ff} is not zero). First, matrix C₀∈C can be positive definite as required by Burkard. Second, assuming that matrix C_{f-1} is positive definite, matrix W_{f} is well-defined because element (W_{f})_{ff}=−1. Therefore, the f-th column of matrix W_{f} is linearly independent of other columns of matrix W_{f} (as the other columns of W_{f} constitute an identity matrix by definition). Thus, W_{f} has full rank, which implies matrix C_{f}≡W_{f}C_{f-1}W_{f}^{T} is also positive definite.

The final matrix:

C′≡WCW^{T} (Equation 3).

where W≡Π_{f=1}^{F} W_{f}, has vanishing off-diagonal elements for its first F rows and columns, which can be verified as follows. The off-diagonal entries of f-th column of matrix C_{f} can be calculated as:

$${( {C}_{f} )}_{if} = {\sum }_{j , k = 1}^{n} {( {W}_{f} )}_{ij} {( {C}_{f - 1} )}_{jk} {( {W}_{f} )}_{fk} = - {\sum }_{j = 1}^{n} {( {W}_{f} )}_{ij} {( {C}_{f - 1} )}_{jf} = - [ - \frac{{( {c}_{f - 1} )}_{if}}{{( {c}_{f - 1} )}_{ff}} {( {C}_{f - 1} )}_{ff} + 1 \times {( {C}_{f - 1} )}_{if} ] = 0 .$$

Due to symmetry of matrix C_{f}, off-diagonal entries in the f-th row matrix C_{f} are also vanishing, i.e., zeros. It can also be shown that off-diagonal terms of matrix C_{f} for 1 to f−1-th rows and 1 to f−1-th columns are also vanishing, which can be established by induction. First, this is true for matrix C₁. Second, it is assumed that the same is true for matrix C_{f}, which implies element (C_{f})_{if+1}=0 (for i<f+1), which implies that the same is true for matrix W_{f+1}, i.e., (W_{f+1})_{if+1}=0 (for i<f+1). By symmetry, the same holds for the f+1-th row of matrix C_{f} and the same holds true for matrix W_{f+1}. Hence, both matrices C_{f} and W_{f+1}, and therefore matrix W_{f+1}^{T} are block diagonal matrices with block dimensions 1, . . . , 1, n−f, which implies the same is true for matrix C_{f+1}.

As established above, every matrix W_{f} is full rank and therefore invertible, which implies that transform matrix W is invertible. Hence, transformed charge coupling matrix

C′⁻¹=(W^{T})⁻¹C⁻¹W⁻¹ (Equation 4).

is well defined. Since transformed charge matrix C′ is block diagonal with block dimensions 1, . . . , 1, n−F, transformed charge coupling matrix C′⁻¹ is also block diagonal with block dimensions 1, . . . , 1, n−F.

Furthermore, the submatrices of charge coupling matrix C⁻¹ and transformed charge coupling matrix C′⁻¹ that correspond to indices greater than F (the number of free modes) are the same. This can be proved as follows. W_{f}⁻¹=W_{f} is established because when i=j:

(W_{f}W_{f})ᵢᵢ=Σₖ₌₁ⁿ(W_{f})ᵢₖ(W_{f})ₖᵢ=(W_{f})ᵢᵢ²=1;

and when i≠j:

$${( {W}_{f} {W}_{f} )}_{ij} = {\sum }_{k = 1}^{n} {( {W}_{f} )}_{ik} {( {W}_{f} )}_{k j} = {( {W}_{f} )}_{i i} {( {W}_{f} )}_{i j} + {( {W}_{f} )}_{i f} {( {W}_{f} )}_{i j} = {δ}_{j f} ( {( {W}_{f} )}_{i i} {( {W}_{f} )}_{i f} + {( {W}_{f} )}_{i f} {( {W}_{f} )}_{f f} ) = {δ}_{j f} ( {( {W}_{f} )}_{i f} - {( {W}_{f} )}_{i f} ) = 0$$

where δ_{jf}((W_{f})_{if}−(W_{f})_{if}) follows because i≠j and i≠f. Here, δ_{jf}=1 when j=f and δ_{jf}=0 when j≠f.

For i, j>F, the following relationship is established:

$${( {C}_{f}^{- 1} )}_{i j} = {( {W}_{f}^{T} {C}_{f - 1}^{- 1} {W}_{f} )}_{i j} = {\sum }_{k , l = 1}^{n} {( {W}_{f} )}_{k i} {( {C}_{f - 1}^{- 1} )}_{k l} {( {W}_{f} )}_{l j} = {( {W}_{f} )}_{i i} {( {C}_{f - 1}^{- 1} )}_{i j} {( {W}_{f} )}_{j j} = {( {C}_{f - 1}^{- 1} )}_{i j}$$

Therefore, the submatrices of charge coupling matrix C⁻¹ and transformed charge coupling matrix C′⁻¹ that correspond to indices greater than F are the same. Thus, the linear transformation does not affect the charge couplings of the non-free modes of the original Hamiltonian.

The linear transformation of the charge operators \vec{Q}′ can be defined as:

\vec{Q}′→W\vec{Q} (Equation 5).

In order to preserve the following canonical commutation relations between canonical conjugate quantities in the Hamiltonian,

[Φᵢ,Φᵢ)]=0

[Qᵢ,Qᵢ]=0

[Φᵢ,Qᵢ]=iℏδᵢⱼ

the flux operator \vec{Φ} can also be transformed as:

\vec{Φ}→(W^{T})⁻¹\vec{Φ} (Equation 6).

This preserves the canonical commutation relations. For i>F, Φᵢ=τⱼ Wⱼᵢ Φⱼ′=Φᵢ′, where \vec{Φ′}≡(W^{T})⁻¹\vec{Φ} are the transformed flux operators. Accordingly, consistent with disclosed embodiments, the transformed fluxes include the original non-free mode's fluxes. Thus, by removing the free modes in the Hamiltonian in terms of the transformed modes, the Hamiltonian on the original non-free modes can be explicitly obtained. Furthermore, any junction terms in the Hamiltonian are preserved and remain local terms (e.g., terms that involve a single mode, as contrasted with general terms that involve multiple modes, which can be expressed as sums of tensor products of local operators).

Consistent with disclosed embodiments, the linear transformation of the flux modes implies a corresponding transformation of the flux coupling matrix:

M₀→WM₀W^{T} (Equation 7).

This transformation, however, does not affect the element values of the flux coupling matrix, as shown below:

$$\begin{matrix}{( {W}_{f} {M}_{0} {W}_{f}^{T} )}_{i j} = {\sum }_{k , l = 1}^{n} {( {W}_{f} )}_{i k} {( {M}_{0} )}_{k l} {( {W}_{f} )}_{j l} = \\ {\sum }_{k = i , f , l = i , f} {( {W}_{f} )}_{i k} {( {M}_{0} )}_{k l} {( {W}_{f} )}_{j l} \\ = {( {W}_{f} )}_{i i} {( {M}_{0} )}_{i j} {( {W}_{f} )}_{j j} = {( {M}_{0} )}_{i j}\end{matrix}$$

since the f-th row and f-th column of M₀ are both zero. Accordingly:

M₀=WM₀W^{T}

Therefore, the transformed flux coupling matrix is the same as the original flux coupling matrix.

A similar result holds for the external flux coupling matrix N. The linear transformation of the flux modes implies a corresponding linear transformation of the external flux coupling matrix:

N→WN (Equation 8).

However

$${( {W}_{f} N )}_{ij} = {\sum }_{k = 1}^{n} {( {W}_{f} )}_{i k} {N}_{k j} = {( {W}_{f} )}_{i i} {N}_{i j} = {N}_{i j}$$

Therefore N=WN and the external flux coupling matrix is not affected by the linear transformation of the flux modes. The first F modes in the transformed external flux coupling matrix N are free modes and the flux and external flux couplings of the remaining modes (i.e., non-free modes) of modes remain the same.

The linear transformation implies a corresponding linear transformation of voltage coupling matrix C_{V}:

C_{V}→WC_{V} (Equation 9).

According to some embodiments of the present disclosure, based on Equations 3 to 9, the Hamiltonian of Equation 1 can be represented in terms of the transformed modes as follows:

$$H = \frac{1}{2} {( {\vec{Q}}^{′} - {C}_{V}^{′} \vec{V} )}^{T} {C}^{′ - 1} ( {\vec{Q}}^{′} - {C}_{V}^{′} \vec{V} ) - {\sum }_{i = 1}^{{n}_{J}} {E}_{J , i} cos ( \frac{2 π}{{Φ}_{0}} {Φ}_{i}^{′} ) + \frac{1}{2} {\vec{Φ}}^{′ T} {M}_{0} {\vec{Φ}}^{′} + {\vec{Φ}}^{′ T} N \vec{{Φ}_{x}} . \qquad ( Equation 10 )$$

Here, the transformed Hamiltonian expressed as Equation 10 describes a system of n modes with F free modes that are independent from all other modes. Therefore, according to some embodiments of the present disclosure, the Hamiltonian of the original non-free modes can be extracted by eliminating terms corresponding to free modes' charges from the Hamiltonian of Equation 10.

Referring back to FIG. 2B, Hamiltonian extraction unit 222 can be configured to generate an extracted Hamiltonian of quantum circuit 201, e.g., by removing components of the transformed Hamiltonian corresponding to free modes. The extracted Hamiltonian can be represented as follows:

$${H}_{∖ F} = \frac{1}{2} {\vec{Q}}_{∖ F}^{′ T} {C}_{∖ F}^{- 1} {\vec{Q}}_{∖ F}^{′} - {\sum }_{i = 1}^{{n}_{J}} {E}_{J , i} cos ( \frac{2 π}{{Φ}_{0}} {Φ}_{i} ) + \frac{1}{2} {{\vec{Φ}}_{∖ F}^{T} ( {M}_{0} )}_{∖ F} {\vec{Φ}}_{∖ F} + {\vec{Φ}}_{∖ F}^{T} {N}_{\backslash F} \vec{{Φ}_{x}} - {[ {( {C}_{V}^{′} )}_{∖ F} \vec{V} ]}^{T} {C}_{∖ F}^{- 1} {\vec{Q}}_{∖ F}^{′} . \qquad ( Equation 11 )$$

In Equation 11, the subscript \F means that components corresponding to free modes have been removed from the corresponding operators or matrices. According to some embodiments of the present disclosure, for external flux coupling matrix N and transformed voltage coupling matrix C′_{V}, symbol \F can mean removing rows corresponding to free modes of the transformed Hamiltonian.

Consistent with disclosed embodiments, the extracted Hamiltonian H_{\F} of Equation 11 may not include the identity term proportional to V² (where V is the vector of voltage biases in the circuit). In some embodiments, this term may contribute only a shift to the Hamiltonian and can be disregarded.

Consistent with disclosed embodiments, the drive term proportional to V in the extracted Hamiltonian H_{\F} can equal [(C′_{V})_{\F}\vec{V}]^{T}C_{\F}⁻¹\vec{Q}′_{\F}. As shown below, this relationship can follow from the block-diagonal nature of the transformed charge coupling matrix C′⁻¹ and the equivalence between the submatrices of the charge coupling matrix C⁻¹ and the extracted portion of the transformed charge coupling matrix C′⁻¹ corresponding to the non-free modes of the original Hamiltonian. As support for this relationship, consider the following drive term, which includes the free mode:

−(C′_{V}\vec{V})^{T}C′⁻¹\vec{Q}′

Removing free modes from this drive term is equivalent to removing the first F columns of transformed charge coupling matrix C′⁻¹ and the first F entries of transformed charge operator \vec{Q}′. Because transformed charge coupling matrix C′⁻¹ is a block diagonal matrix, the first F rows, once the first F columns of transformed charge coupling matrix C′⁻¹ are removed, are all zeros. Therefore, the first F rows of transformed charge coupling matrix C′⁻¹ and the first F rows of transformed voltage coupling matrix C′_{V} can also be removed. As explained above, the remaining submatrix of transformed charge coupling matrix C′⁻¹ after removing free modes is the same as that of charge coupling matrix C⁻¹ and thus the drive term of the extracted Hamiltonian H_{\F} can be represented as in Equation 11.

Consistent with disclosed embodiments and in accordance with the derivation of the extracted Hamiltonian provided herein, the extracted Hamiltonian can be obtained by removing the free mode terms in the original Hamiltonian and transforming the voltage coupling matrix C_{V} as depicted in Equation 9. The transformation of the voltage coupling matrix may ensure, in some embodiments, that an analysis using the extracted Hamiltonian in place of the original Hamiltonian will provide the correct results when using voltage sources.

Referring back to FIG. 2B, quantum circuit simulation unit 223 can be configured to simulate a behavior of quantum circuit 201 using the extracted Hamiltonian H_{\F}, in accordance with disclosed embodiments. According to some embodiments of the present disclosure, a simulation of quantum circuit 201 can be performed by a classical computer. In some embodiments, the simulation of quantum circuit 201 can be used to verify or evaluate whether quantum circuit 201 shows behaviors or performance as designed or planned. In some embodiments, eigenvalues that can be used for analyzing quantum circuit 201 can be obtained from an extracted Hamiltonian H_{\F} that represents quantum circuit 201. According to some embodiments of the present disclosure, quantum circuit simulation unit 223 can determine an energy spectrum of quantum circuit 201 based on extracted Hamiltonian H_{\F}. According to some embodiments of the present disclosure, a spectrum of relevant eigenvalues for quantum information processing can be obtained from extracted Hamiltonian H_{\F} of quantum circuit 201. In some embodiments, extracted Hamiltonian H_{\F} can be used to obtain discrete energy eigenvalues suitable for analyzing quantum circuit 201. As a non-limiting example, these discrete energy eigenvalues can be used to determine the qubit frequencies for quantum circuit 201 (e.g., as the difference between the two lowest eigenvalues, or the like). In some embodiments, the frequency of a qubit indicates a frequency that can be used to control the corresponding qubit.

Referring back to FIG. 2A, quantum circuit adjuster 230 can be configured to adjust the quantum circuit based on a simulation result, e.g., by quantum circuit simulation unit 223 of FIG. 2B. In some embodiments, when the simulation result shows that quantum circuit 201 behaves as planned or designed, quantum circuit adjuster 230 may confirm that no adjustment is needed or that the quantum circuit 201 is optimum. In some embodiments, when the simulation result indicates that quantum circuit 201 does not behave as designed or planned, quantum circuit adjuster 230 can adjust quantum circuit 201, e.g., by changing a design of the quantum circuit 201 including changing connections of the circuit, choosing different circuit elements (e.g., capacitor, inductor, resistor, etc.), choosing different parameter values for circuit elements, and so on. In some embodiments, quantum circuit adjuster 230 can adjust quantum circuit 201 such that the quantum circuit 201 can adequately behave as it is planned or designed or such that the quantum circuit 201 can behave to provide optimal performance in view of its purpose.

Consistent with disclosed embodiments, quantum circuit adjuster 230 can be configured to adjust the design of the quantum circuit automatically. In some embodiments, quantum circuit optimizer 200 can be configured to search a space of parameters for quantum circuit designs satisfying some specification (e.g., a cost function). The disclosed embodiments are not limited to any particular search algorithm. As non-limiting examples, quantum circuit optimizer 200 can perform a Monte Carlo search, a gradient descent search, a machine learning search (e.g., a genetic algorithm or the like), or another suitable search.

Consistent with disclosed embodiments, quantum circuit adjuster 230 can be configured to adjust the design in response to user input. For example, a user can interact with an interface provided by quantum circuit optimizer 200. In some instances, the user can view the results of a circuit simulation. In various instances, the user can provide instructions using the interface. The instructions can cause quantum circuit adjuster 230 to modify a design of the quantum circuit. In some instances, the instructions can cause quantum circuit simulator 220 to run or rerun the modified quantum circuit. Quantum circuit optimizer 200 can then display the results of simulating the modified quantum circuit, permitting the user to instruct further modifications. In some embodiments, quantum circuit optimizer 200 can combine automated searching with user instructions. For example, a user can interact with quantum circuit optimizer 200 to configure one or more automatic searches, or to view the results of one or more automatic searches.

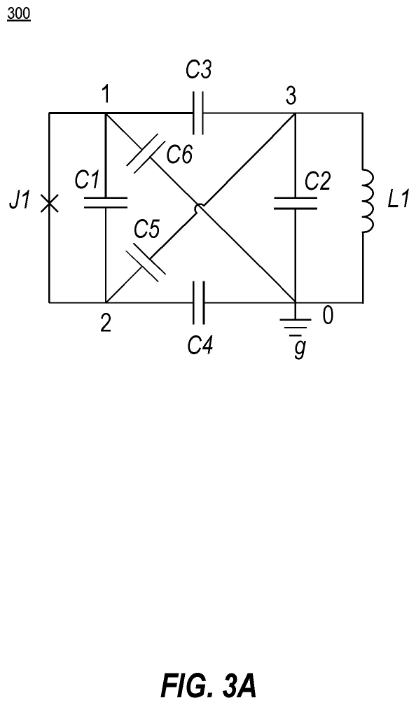

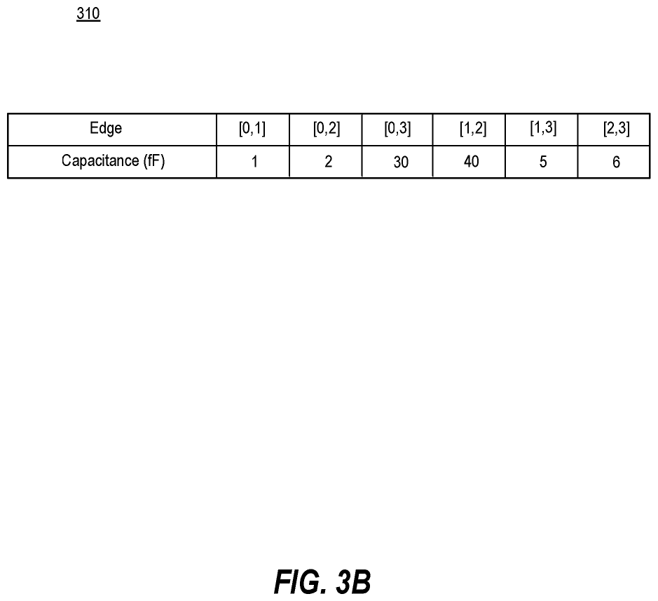

FIG. 3A illustrates an example quantum circuit, consistent with some embodiments of the present disclosure. Referring to quantum circuit 300 of FIG. 3A, a process of generating a Hamiltonian of quantum circuit 300 and of removing free modes from the Hamiltonian will be described for illustration purposes. It will be appreciated that circuit elements and nodes are labeled for reference in FIG. 3A for reference. As shown in FIG. 3A, quantum circuit 300 comprises a Cooper-pair box and a resonator capacitively coupled to the Cooper-pair box. In quantum circuit 300, the Cooper-pair box includes parallelly connected Josephson junction J1 (e.g., having Josephson junction energy L_{q}) and capacitor C1 (e.g., having capacitance C_{q}). To continue this example, the resonator includes parallelly connected inductor L1 (e.g., having inductance Lᵣ) and capacitor C2 (e.g., having capacitance C_{rg}). In quantum circuit 300, the Cooper-pair box and the resonator are capacitively coupled by capacitors C3 (e.g., having capacitance C₁ᵣ), C4 (e.g., having capacitance C_{2g}), C5 (e.g., having capacitance C₂ᵣ), and capacitance C6 (e.g., having capacitance C_{1g}). The ground node is indicated as reference g. In quantum circuit 300, Josephson junction J1 and capacitor C1 together constitutes a qubit.

As defined in Burkard, charge coupling matrix C⁻¹ and flux coupling matrix M₀ of quantum circuit 300 in FIG. 3A can be obtained as below:

$${C}^{- 1} = {[ \begin{matrix}{C}_{1 g} + {C}_{2 g} + {C}_{1 r} + {C}_{2 r} & {C}_{2 g} + {C}_{2 r} & - {C}_{1 r} - {C}_{2 r} \\ {C}_{2 g} + {C}_{2 r} & {C}_{2 g} + {C}_{q} + {C}_{2 r} & - {C}_{2 r} \\ - {C}_{1 r} - {C}_{2 r} & - {C}_{2 r} & {C}_{r g} + {C}_{1 r} + {C}_{2 r}\end{matrix} ]}^{- 1}$$

$${M}_{0} = [ \begin{matrix}0 & 0 & 0 \\ 0 & 0 & 0 \\ 0 & 0 & {L}_{r}^{- 1}\end{matrix} ]$$

It will be noted that external fluxes or voltage sources are not considered in analyzing quantum circuit 300 of FIG. 3A for simplicity. Based on Equation 1, a Hamiltonian of quantum circuit 300 can be expressed as below:

$$H = \frac{1}{2} {\vec{Q}}^{T} {C}^{- 1} \vec{Q} - {L}_{q} cos ( \frac{2 π}{{Φ}_{0}} {Φ}_{q} ) + \frac{1}{2} {L}_{r}^{- 1} {Φ}_{r}^{2}$$

Here, charge operator \vec{Q} and flux operator \vec{Φ} of quantum circuit 300 can be expressed as \vec{Q}=[Q_{1g}, Q_{q}, Qᵣ]^{T} and \vec{Φ}=[Φ_{1g}, Φ_{q}, Φᵣ] It will be noted that subscripts describe which branch of quantum circuit 300 the observables (e.g., operators) correspond to and the same subscripts will be used to denote modes of quantum circuit 300 and their corresponding subspaces in the present disclosure. For example, charge operator Q_{1g} corresponds to a branch between node 1 and node 0 (i.e., ground node g), charge operator Q_{q} corresponds to a branch between node 1 and node 2, and charge operator Qᵣ corresponds to a branch between node 3 and node 0.

In this non-limiting example, three modes are sufficient to describe quantum circuit 300. One of the modes is free because the inductor subspace is spanned by subspace 1g and subspace r, and the kernel of flux coupling matrix M₀ is spanned by subspace q and subspace 1g and thus there is one subspace 1g there between. Therefore, the exemplary original Hamiltonian for quantum circuit 300 includes a single free mode. When a Hamiltonian including free modes is diagonalized, e.g., by using a Lanczos algorithm, to obtain eigenvalues, the same eigenvalue may always appear as the lowest eigenvalue because the free modes render the spectrum of quantum circuit 300 continuous.

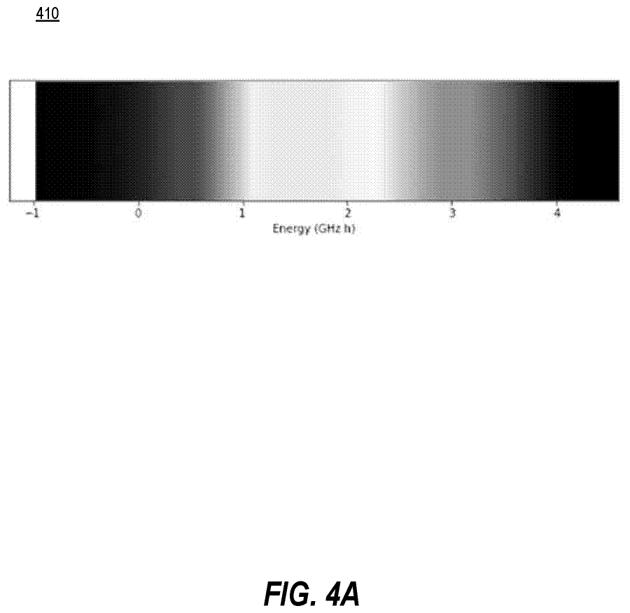

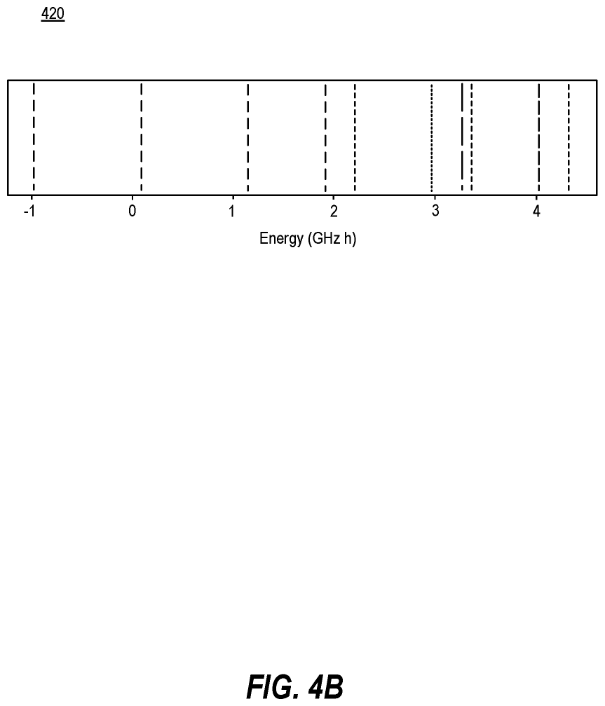

FIG. 3B illustrates an example capacitance table of quantum circuit 300 of FIG. 3A, consistent with some embodiments of the present disclosure. In table 310 of FIG. 3B, a capacitance value corresponding to each branch is listed. For example, a capacitance value corresponding to a branch between node 0 and node 1 is 1 femtofarad (fF), a capacitance value corresponding to a branch between node 0 and node 2 is 2 fF, and so on. Here, in addition to capacitance values in table 310 of FIG. 3B, inductor value Lᵣ=700 nH, and Josephson junction energy value E_{J}=L_{q}=3 GHz h are used for illustration purposes. In this example, the ten lowest eigenvalues can be computed as −0.965 GHz·h. Thus, a spectrum of discrete energy levels is not obtained. Instead, as shown in FIG. 4A, the energy spectrum covers all real numbers greater than or equal to −0.965 GHz·h.

In some embodiments, a change of basis may be required to identify the free modes of the quantum circuit. In this non-limiting example, however, the free mode can be identified by inspection. In this example, mode 1g has no potential term and thus mode 1g is a free mode in quantum circuit 300. Since by Equation 2, quantum circuit 300 has one free mode, the linear transformation matrix W for quantum circuit 300 can be expressed as:

$$W = {W}_{1} = [ \begin{matrix}- 1 & 0 & 0 \\ - ( {C}_{2 g} + {C}_{2 r} ) / {C}_{c} & 1 & 0 \\ ( {C}_{1 r} + {C}_{2 r} ) / {C}_{c} & 0 & 1\end{matrix} ]$$

where C_{c}≡C_{1g}+C_{2g}+C₁ᵣ+C₂ᵣ.
Based on Equation 3, transformed effective capacitance matrix C′ for quantum circuit 300 can be expressed as:

$${C}^{l} ≡ {WCW}^{T} = [ \begin{matrix}{C}_{c} & 0 & 0 \\ 0 & \begin{matrix}[ ( {C}_{1 g} + {C}_{1 r} ) ( {C}_{2 g} + {C}_{2 r} ) / {C}_{c} ] + \\ {C}_{q}\end{matrix} & ( {C}_{1 r} {C}_{2 g} - {C}_{1 g} {C}_{2 r} ) / {C}_{c} \\ 0 & ( {C}_{1 r} {C}_{2 g} - {C}_{1 g} {C}_{2 r} ) / {C}_{c} & \begin{matrix}[ ( {C}_{1 g} + {C}_{2 g} ) ( {C}_{1 r} + {C}_{2 r} ) / {C}_{c} ] + \\ {C}_{r g}\end{matrix}\end{matrix} ]$$

It is noted that transformed capacitance matrix C′ of quantum circuit 300 is block diagonal, as illustrated with respect to Equation 3 and Equation 4. Given transform matrix W and charge operator \vec{Q}, transformed charge operator \vec{Q}′≡W\vec{Q}, and transformed flux operator \vec{Φ}′≡(W^{T})⁻¹\vec{Φ} of quantum circuit 300 can be expressed as below:

$${\vec{Q}}^{′} = [ {Q}_{1 g}^{′} , {Q}_{q}^{′} , {Q}_{r}^{′} ] = W \vec{Q} = {[ - {Q}_{1 g} , - \frac{{C}_{2 g} + {C}_{2 r}}{{C}_{c}} {Q}_{1 g} + {Q}_{q} , \frac{{C}_{1 r} + {C}_{2 r}}{{C}_{c}} {Q}_{1 g} + {Q}_{r} ]}^{T}$$

$${\vec{Φ}}^{′} = [ {Φ}_{1 g}^{′} , {Φ}_{q}^{′} , {Φ}_{r}^{′} ] = {( {W}^{T} )}^{- 1} \vec{Φ} = {[ - {Φ}_{1 g} - \frac{{C}_{2 g} + {C}_{2 r}}{{C}_{c}} {Φ}_{q} + \frac{{C}_{1 r} + {C}_{2 r}}{{C}_{c}} {Φ}_{r} , {Φ}_{q} , {Φ}_{r} ]}^{T}$$

As illustrated with respect to Equation 6, it is noted that flux operators of non-free modes are preserved as Φ_{q} and Φᵣ.

Therefore, based on Equation 11, the extracted Hamiltonian H_{/F} for quantum circuit 300 can be expressed as below:

$${H}_{∖ F} = {{\frac{1}{2} [ {Q}_{2}^{′} , {Q}_{3}^{′} ] [ \begin{matrix}\begin{matrix}[ ( {C}_{1 g} + {C}_{1 r} ) ( {C}_{2 g} + {C}_{2 r} ) / {C}_{c} ] + \\ {C}_{q}\end{matrix} & ( {C}_{1 r} {C}_{2 g} - {C}_{1 g} {C}_{2 r} ) / {C}_{c} \\ ( {C}_{1 r} {C}_{2 g} - {C}_{1 g} {C}_{2 r} ) / {C}_{c} & \begin{matrix}[ ( {C}_{1 g} + {C}_{2 g} ) ( {C}_{1 r} + {C}_{2 r} ) / {C}_{c} ] + \\ {C}_{r g}\end{matrix}\end{matrix} ]}^{- 1} [ {Q}_{2}^{′} , {Q}_{3}^{′} ]}^{T} - {L}_{q} cos ( \frac{2 π}{{Φ}_{0}} {Φ}_{q} ) + \frac{1}{2} {L}_{r}^{- 1} {Φ}_{r}^{2}$$

In this trivial example, extracted Hamiltonian H_{\F} of quantum circuit can be obtained by simply removing free mode terms from the original Hamiltonian. However, decoupling the free modes in a more complicated example may be more difficult. Furthermore, this example demonstrates how to generate the transformation matrix W, which can be necessary for obtaining the correct voltage source term in the extracted Hamiltonian. In this trivial example, the extracted Hamiltonian does not include such a voltage source term.

In order to evaluate an energy spectrum of quantum circuit 300, the extracted Hamiltonian can be diagonalized. The diagonalized Hamiltonian can be used to obtain the spectrum of discrete energy eigenvalues depicted in FIG. 4B, consistent with some embodiments of the present disclosure. Given these discrete energy eigenvalues, a frequency of the qubit can be determined as the difference between the two lowest eigenvalues. This frequency can be used for quantum information processing (e.g., 1.06 GHz=0.0928−(−0.965) in FIG. 4B). In this manner, a spectrum of relevant modes for quantum information processing can be obtained using the extracted Hamiltonian for quantum circuit 300.

According to some embodiments of the present disclosure, a scheme for handling free modes in general superconducting quantum circuits is provided. According to some embodiments of the present disclosure, a linear transformation matrix can be determined using an effective capacitance matrix of an original Hamiltonian of a quantum circuit. The linear transformation matrix can depend on the effective capacitance matrix for the original Hamiltonian. The linear transformation matrix can be used to transform the original Hamiltonian into a transformed Hamiltonian. The linear transformation matrix can be used to generate a transformed charge coupling matrix from the charge coupling matrix of the original Hamiltonian. The transformed charge coupling matrix can be block diagonal, including a free mode submatrix and a non-free mode submatrix. The non-free mode submatrix of the transformed charge coupling matrix can equal the equivalent submatrix of the original charge coupling matrix. The linear transformation matrix can similarly be used to transform the charge operators, flux operators, and voltage coupling matrix of the original Hamiltonian. An extracted Hamiltonian can be obtained from the transformed Hamiltonian by removing the free modes of the transformed Hamiltonian. The extracted Hamiltonian can be used to simulate the circuit (e.g., following diagonalization, or the use of another suitable analysis technique).

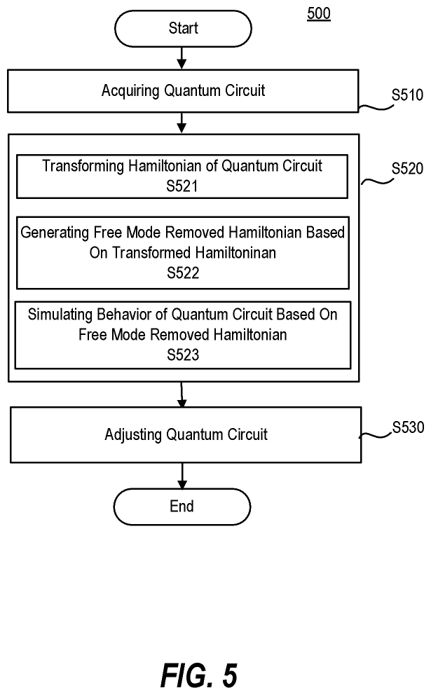

FIG. 5 illustrates an exemplary flow diagram of a method for optimizing a quantum circuit, consistent with some embodiments of the present disclosure. For illustrative purposes, a method for optimizing a quantum circuit will be described referring to quantum circuit optimizer 200 of FIG. 2A and quantum circuit simulator of FIG. 2B. It is appreciated that in some embodiments at least part of a method for optimizing a quantum circuit can be performed in or, directly or indirectly, by a combination of processor 110 and optimizer 140 of FIG. 1.

In step S510, a representation of quantum circuit 201 can be acquired. Step S510 can be performed by, for example, quantum circuit acquirer 210, among others. In some embodiments, an initial quantum circuit—the quantum circuit to be optimized—may be acquired by various means. For example, in some embodiments the initial quantum circuit may be acquired as input. This input could come in a variety of forms, both in how the input is represented (e.g., the data structure involved) and what the input represents (e.g., what quantum circuit representation the input is using). Additionally, as mentioned above, the disclosed embodiments are not limited to any particular representation of the quantum circuit.

In step S520, a behavior of quantum circuit 201 can be simulated. Step S520 can be performed by, for example, quantum circuit simulator 220, among others. According to some embodiments of the present disclosure, step S520 can be performed by three sub-steps S521, S522, and S523.

In sub-step S521, a Hamiltonian of quantum circuit 201 can be transformed to generate a transformed Hamiltonian. Step S521 can be performed by, for example, Hamiltonian transformation unit 221, among others. According to some embodiments of the present disclosure, a transformed Hamiltonian can be generated using a linear transformation matrix to decouple free modes from other circuit modes in the original Hamiltonian. An exemplary process for transforming an original Hamiltonian has been explained with respect to Equations 1 to 10. A similar process can be used in sub-step S521. Accordingly, as described herein and consistent with disclosed embodiments, a transformed Hamiltonian as expressed in Equation 10 can be generated from an original Hamiltonian as expressed in Equation 1.

In sub-step S522, an extracted Hamiltonian can be generated based on a transformed Hamiltonian. Step S522 can be performed by, for example, Hamiltonian extraction unit 222, among others. According to some embodiments of the present disclosure, the extracted Hamiltonian of quantum circuit 201 can be generated, e.g., by removing free mode from the transformed Hamiltonian. According to some embodiments of the present disclosure, free modes can be removed from a transformed Hamiltonian without affecting non-free modes components because, in the transformed Hamiltonian, free modes are decoupled from other circuit modes. According to some embodiments of the present disclosure, free modes can be removed from the transformed Hamiltonian in terms of transformed modes as represented in Equation 10. According to some embodiments of the present disclosure, the extracted Hamiltonian can be expressed as Equation 11.

In sub-step S523, a behavior of quantum circuit 201 can be simulated based on the extracted Hamiltonian of quantum circuit 201. Step S523 can be performed by, for example, quantum circuit simulation unit 223, among others. According to some embodiments of the present disclosure, a simulation of quantum circuit 201 can be performed by a classical computer. In some embodiments, the simulation of quantum circuit 201 can be used to verify or evaluate whether quantum circuit 201 shows behaviors or performance as designed or planned. In some embodiments, eigenvalues that can be used for analyzing quantum circuit 201 can be obtained from extracted Hamiltonian H_{\F} of quantum circuit 201. According to some embodiments of the present disclosure, energy spectrum of quantum circuit 201 can be simulated based on the extracted Hamiltonian H_{\F}. According to some embodiments of the present disclosure, a spectrum of relevant modes for quantum information processing can be obtained from extracted Hamiltonian H_{\F} of quantum circuit 201. In some embodiments, extracted Hamiltonian H_{\F} can be diagonalized e.g., by using a Lanczos algorithm. According to some embodiments of the present disclosure, by diagonalizing extracted Hamiltonian H_{\F}, discrete energy eigenvalues can be obtained. Based on discrete energy eigenvalues, a frequency of a qubit, which consists of modes (e.g., non-free modes) relevant for quantum information processing, can be computed. In some embodiments, a frequency of a qubit can be the difference between the two lowest eigenvalues. In some embodiments, the frequency of a qubit indicates a frequency that can be used to control the corresponding qubit.

In step S530, quantum circuit 201 can adjusted. Step S530 can be performed by, for example, quantum circuit adjuster 230, among others. In some embodiments, when the simulation result shows that quantum circuit 201 behaves as planned or designed, adjustment may not be needed. In some embodiments, when the simulation result indicates that quantum circuit 201 does not behave as designed or planned, quantum circuit 201 can be adjusted, e.g., by changing a design of the quantum circuit 201 including changing connections of the circuit, choosing different circuit elements (e.g., capacitor, inductor, resistor, etc.), choosing different parameter values for circuit elements, and so on. In some embodiments, quantum circuit 201 may be adjusted such that the quantum circuit 201 can adequately behave as it is planned or designed or such that the quantum circuit 201 can behave to provide optimal performance in view of its purpose. As described herein, such adjustments can be automatic, or at least partially manual.

The embodiments may further be described using the following clauses:
1. A method for optimizing a quantum circuit, comprising: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and, adjusting a design of the quantum circuit based on the simulated behavior of the quantum circuit.
2. The method of clause 1, wherein transforming the first Hamiltonian to generate the second Hamiltonian comprises: transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.
3. The method of clause 2, wherein transforming the first Hamiltonian to generate the second Hamiltonian further comprises: transforming a charge operator of the first Hamiltonian using the linear transformation matrix.
4. The method of clause 2 or 3, wherein transforming the first Hamiltonian to generate the second Hamiltonian further comprises: transforming a flux operator of the first Hamiltonian such that a canonical commutation relation of the first Hamiltonian is preserved in the second Hamiltonian.
5. The method of any one of clause 1 to 4, further comprises performing Gaussian elimination on an effective capacitance matrix of the first Hamiltonian using the linear transformation matrix.
6. The method of any one of clause 1 to 5, wherein simulating the behavior of the quantum circuit using the third Hamiltonian comprises: obtaining discrete energy eigenvalues of the quantum circuit by diagonalizing the third Hamiltonian.
7. The method of any one of clause 1 to 6, wherein the behavior of the quantum circuit comprises a frequency of a qubit among the one or more qubits.
8. An apparatus for optimizing a quantum circuit, comprising: a memory for storing a set of instructions; and, at least one processor configured to execute the set of instructions to cause the apparatus to perform operations including: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and adjusting a design of the quantum circuit based on the simulated behavior of the quantum circuit.
9. The apparatus of clause 8, wherein transforming the first Hamiltonian to generate the second Hamiltonian includes: transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.
10. The apparatus of clause 9, wherein in transforming the first Hamiltonian to generate the second Hamiltonian further includes: transforming a charge operator of the first Hamiltonian using the linear transformation matrix.
11. The apparatus of clause 9 or 10, wherein in transforming the first Hamiltonian to generate the second Hamiltonian further includes: transforming a flux operator of the first Hamiltonian such that a canonical commutation relation of the first Hamiltonian is preserved in the second Hamiltonian.
12. The apparatus of any one of clause 8-11, wherein the linear transformation matrix is configured to perform Gaussian elimination on an effective capacitance matrix of the first Hamiltonian.
13. The apparatus of any one of clause 8-12, wherein simulating the behavior of the quantum circuit using the third Hamiltonian further comprises: obtaining discrete energy eigenvalues of the quantum circuit by diagonalizing the third Hamiltonian.
14. The apparatus of any one of clause 7-10 wherein the behavior of the quantum circuit comprises a frequency of a qubit among the one or more qubits.
15. A non-transitory computer readable medium that stores a set of instructions that is executable by at least one processor of a computing device to perform a method for optimizing a quantum circuit, the method comprising: acquiring a representation of a quantum circuit comprising one or more qubits; transforming, using a linear transformation matrix, a first Hamiltonian corresponding to the quantum circuit to generate a second Hamiltonian in which free modes are decoupled from non-free modes; generating a third Hamiltonian by removing the free modes from the second Hamiltonian; simulating a behavior of the quantum circuit using the third Hamiltonian; and adjusting a design of the quantum circuit based on the simulated behavior of the quantum circuit.
16. The computer readable medium of clause 15, wherein in transforming the first Hamiltonian to generate the second Hamiltonian further comprises: transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.
17. The computer readable medium of clause 16, wherein in transforming the first Hamiltonian to generate the second Hamiltonian further comprises: transforming a charge operator of the first Hamiltonian using the linear transformation matrix.
18. The computer readable medium of clause 16 or 17, wherein in transforming the first Hamiltonian to generate the second Hamiltonian further comprises: transforming a flux operator of the first Hamiltonian such that a canonical commutation relation of the first Hamiltonian is preserved in the second Hamiltonian.
19. The computer readable medium of any one of clause 15 to 18, wherein generating the third Hamiltonian further comprises: perform Gaussian elimination on an effective capacitance matrix of the first Hamiltonian using the linear transformation matrix.
20. The computer readable medium of any one of clause 15 to 19, wherein in simulating the behavior of the quantum circuit using the third Hamiltonian further comprises:
obtaining discrete energy eigenvalues of the quantum circuit by diagonalizing the third Hamiltonian.
21. The computer readable medium of any one of clause 15 to 20, wherein the behavior of the quantum circuit comprises a frequency of a qubit among the one or more qubits.

Embodiments herein include database systems, methods, and tangible non-transitory computer-readable media. The methods may be executed, for example, by at least one processor that receives instructions from a tangible non-transitory computer-readable storage medium (such as of memory 120 of FIG. 1). Similarly, systems consistent with the present disclosure may include at least one processor and memory, and the memory may be a tangible non-transitory computer-readable storage medium. As used herein, a tangible non-transitory computer-readable storage medium refers to any type of physical memory on which information or data readable by at least one processor may be stored. Examples include random access memory (RAM), read-only memory (ROM), volatile memory, non-volatile memory, hard drives, CD ROMs, DVDs, flash drives, disks, registers, caches, and any other known physical storage medium. Singular terms, such as “memory” and “computer-readable storage medium,” may additionally refer to multiple structures, such a plurality of memories or computer-readable storage media. As referred to herein, a “memory” may comprise any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage media may be utilized in implementing a computer-implemented method. The term “non-transitory computer-readable storage medium” should be understood to include tangible items and exclude carrier waves and transient signals.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. A method for optimizing a quantum circuit, comprising:
acquiring a representation of a quantum circuit comprising one or more qubits;
transforming, using a linear transformation matrix, a first Hamiltonian corresponding to the quantum circuit to generate a second Hamiltonian in which free modes are decoupled from non-free modes;
generating a third Hamiltonian by removing the free modes from the second Hamiltonian;
simulating a behavior of the quantum circuit using the third Hamiltonian; and
adjusting a design of the quantum circuit based on the simulated behavior of the quantum circuit.

2. The method of claim 1, wherein transforming the first Hamiltonian to generate the second Hamiltonian comprises:
transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.

3. The method of claim 2, wherein transforming the first Hamiltonian to generate the second Hamiltonian further comprises:
transforming a charge operator of the first Hamiltonian using the linear transformation matrix.

4. The method of claim 2, wherein transforming the first Hamiltonian to generate the second Hamiltonian further comprises:
transforming a flux operator of the first Hamiltonian such that a canonical commutation relation of the first Hamiltonian is preserved in the second Hamiltonian.

5. The method of claim 1, further comprises performing Gaussian elimination on an effective capacitance matrix of the first Hamiltonian using the linear transformation matrix.

6. The method of claim 1, wherein simulating the behavior of the quantum circuit using the third Hamiltonian comprises:
obtaining discrete energy eigenvalues of the quantum circuit by diagonalizing the third Hamiltonian.

7. The method of claim 1, wherein the behavior of the quantum circuit comprises a frequency of a qubit among the one or more qubits.

8. An apparatus for optimizing a quantum circuit, comprising:
a memory for storing a set of instructions; and
at least one processor configured to execute the set of instructions to cause the apparatus to perform operations including:
acquiring a representation of a quantum circuit comprising one or more qubits;
transforming, using a linear transformation matrix, a first Hamiltonian corresponding to the quantum circuit to generate a second Hamiltonian in which free modes are decoupled from non-free modes;
generating a third Hamiltonian by removing the free modes from the second Hamiltonian;
simulating a behavior of the quantum circuit using the third Hamiltonian; and
adjusting a design of the quantum circuit based on the simulated behavior of the quantum circuit.

9. The apparatus of claim 8, wherein transforming the first Hamiltonian to generate the second Hamiltonian includes:
transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.

10. The apparatus of claim 9, wherein in transforming the first Hamiltonian to generate the second Hamiltonian further includes:
transforming a charge operator of the first Hamiltonian using the linear transformation matrix.

11. The apparatus of claim 9, wherein in transforming the first Hamiltonian to generate the second Hamiltonian further includes:
transforming a flux operator of the first Hamiltonian such that a canonical commutation relation of the first Hamiltonian is preserved in the second Hamiltonian.

12. The apparatus of claim 8, wherein the linear transformation matrix is configured to perform Gaussian elimination on an effective capacitance matrix of the first Hamiltonian.

13. The apparatus of claim 8, wherein simulating the behavior of the quantum circuit using the third Hamiltonian further comprises:
obtaining discrete energy eigenvalues of the quantum circuit by diagonalizing the third Hamiltonian.

14. The apparatus of claim 7 wherein the behavior of the quantum circuit comprises a frequency of a qubit among the one or more qubits.

15. A non-transitory computer readable medium that stores a set of instructions that is executable by at least one processor of a computing device to perform a method for optimizing a quantum circuit, the method comprising:
acquiring a representation of a quantum circuit comprising one or more qubits;
transforming, using a linear transformation matrix, a first Hamiltonian corresponding to the quantum circuit to generate a second Hamiltonian in which free modes are decoupled from non-free modes;
generating a third Hamiltonian by removing the free modes from the second Hamiltonian;
simulating a behavior of the quantum circuit using the third Hamiltonian; and
adjusting a design of the quantum circuit based on the simulated behavior of the quantum circuit.

16. The computer readable medium of claim 15, wherein in transforming the first Hamiltonian to generate the second Hamiltonian further comprises:
transforming an inverse of a charge coupling matrix of the first Hamiltonian to an inverse of a transformed charge coupling matrix such that the transformed charge coupling matrix in the second Hamiltonian is block diagonalized into a free mode sector and a non-free mode sector.

17. The computer readable medium of claim 16, wherein in transforming the first Hamiltonian to generate the second Hamiltonian further comprises:
transforming a charge operator of the first Hamiltonian using the linear transformation matrix.

18. The computer readable medium of claim 16, wherein in transforming the first Hamiltonian to generate the second Hamiltonian further comprises:
transforming a flux operator of the first Hamiltonian such that a canonical commutation relation of the first Hamiltonian is preserved in the second Hamiltonian.

19. The computer readable medium of claim 15, wherein generating the third Hamiltonian further comprises:
perform Gaussian elimination on an effective capacitance matrix of the first Hamiltonian using the linear transformation matrix.

20. The computer readable medium of claim 15, wherein in simulating the behavior of the quantum circuit using the third Hamiltonian further comprises:
obtaining discrete energy eigenvalues of the quantum circuit by diagonalizing the third Hamiltonian.

21. The computer readable medium of claim 15, wherein the behavior of the quantum circuit comprises a frequency of a qubit among the one or more qubits.
